(19) United States
(12) Patent Application Publication
(10) Pub. No.: US 2006/0175588 A1
(43) Pub. Date: Aug. 10, 2006

(54) Dual torque coil winch brake

(76) Inventor: Brian M. Lee, West Linn, OR (US)

Correspondence Address: HARNESS, DICKEY & PIERCE, P.L.C., P.O. BOX 828, BLOOMFIELD HILLS, MI, 48303, US

(21) Appl. No.: 11/053,032

(22) Filed: Feb. 8, 2005

(51) Int. Cl. B66D 5/02

(52) U.S. Cl. 254/375

(57) ABSTRACT

A winch is provided wherein braking is achieved by a pair of torque coils frictionally interlocking the brake shaft to the cable drum. A planetary gear reduction mechanism is provided between the shaft and drum and is prevented by such interlocking from producing differential rotation of the drum and thus it effects lockup or braking of the drum.

### FIELD OF THE INVENTION

The present invention relates to winches and more particularly to a braking mechanism for a winch.

### BACKGROUND OF THE INVENTION

Winches are commonly used in off road vehicles and industrial applications. In vehicular applications, winches are commonly mounted to the front bumper of a vehicle. The winch includes a cable drum, and cable wound onto and off of the drum, and a motor and brake mechanism that controls the drum rotation. Vehicular winches can be used to pull the vehicle up steep hills, through mud, and for lowering small vehicles down steep slopes. Lowering a vehicle down a steep slope, in particular, creates a braking problem for the winch. The heavy weight or force pulls against the cable and urges unwinding of the cable from the drum. The drum can be locked against rotations from unwinding quite satisfactorily with a number of brake designs. When the cable is to be controllably played off the winch, such as when lowering the vehicle down a slope, the braking action needs to controllably resist or slow the drum rotation and thereby maintain control over the play out.

Commonly assigned U.S. Pat. Nos. 5,261,646 and 5,482,255 each disclose satisfactory designs while achieving this purpose. However, it is still desirable to provide a simpler brake design that is easier to assemble and has fewer components.

### SUMMARY OF THE INVENTION

Accordingly, the present invention provides a braking mechanism for a winch, wherein the braking mechanism is contained within the winch drum and consists of an input coupler connected to a drive shaft and an output coupler connected to a braking shaft. The output coupler is connected through a gear train to the winch drum. The brake mechanism includes two torque coils that are intertwined in an inverse wrapped spiral configuration to transmit braking torque between an inside surface of the winch drum and the output coupler.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of a winch incorporating the brake mechanism according to the principles of the present invention;

FIG. 2 is a partial cross-sectional view of the winch mechanism incorporating the braking mechanism according to the principles of the present invention;

FIG. 3 is an exploded perspective view of the brake mechanism according to the principles of the present invention; and

FIG. 4 is an assembled perspective view of the brake mechanism according to the principles of the present invention.

### DETAILED DESCRIPTION OF THE PREFERRED EMBODIMENTS

The following description of the preferred embodiment(s) is merely exemplary in nature and is in no way intended to limit the invention, its application, or uses.

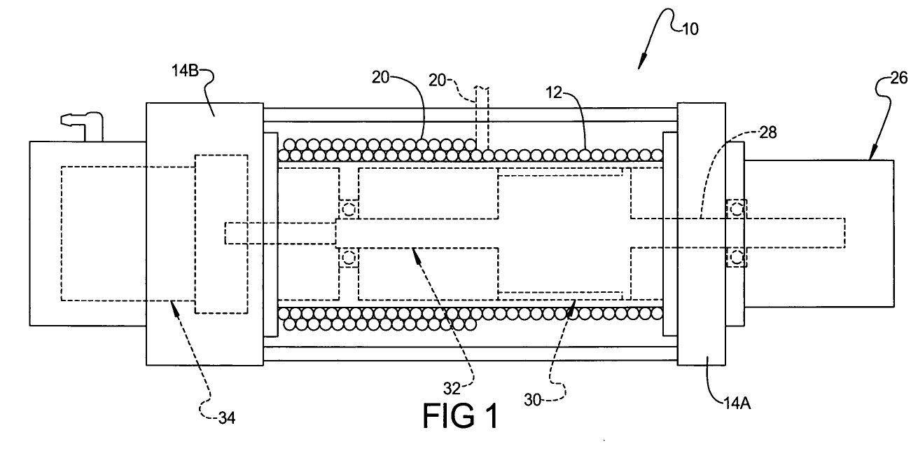

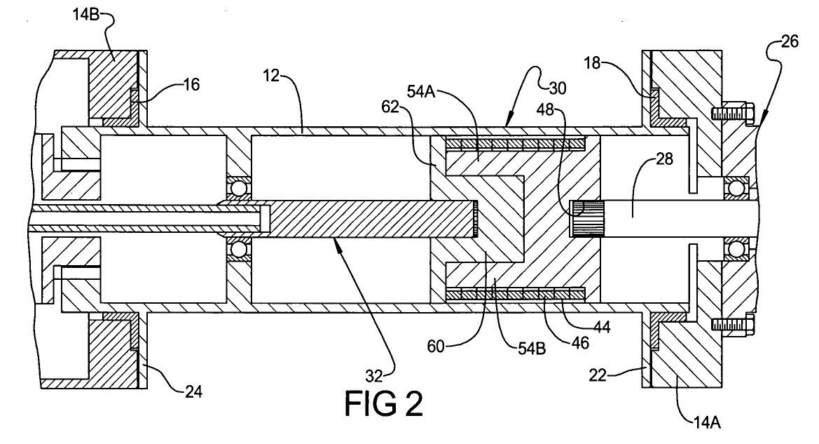

With reference to FIGS. 1 and 2, the illustrated winch 10 includes a cable drum 12 that is supported in a winch housing 14 by bushings 16, 18 as best illustrated in FIG. 2, for axial rotation relative to the stationary housing 14A, 14B. Cable 20 is wound on the drum 12 and is confined by drum flanges 22, 24 which abut against bushings 18, 16, respectively. Cable 20 is either wound onto or off of the drum 12 with rotation of the drum 12. A motor 26 is mounted to the housing end 14A and turns a drive shaft 28. The drive shaft 28 is coupled to a braking mechanism 30 which is coupled to a brake shaft 32. The brake shaft 32 is coupled to a planetary gear assembly 34 contained in the housing end 14B. The planetary gear assembly 34 is engaged with a cable drum 12, as is known in the art. Thus, the motor 26 rotatively drives the drive shaft 28 which transmits torque to the brake shaft 32 via the braking mechanism 30 which rotatively drives the planetary gear assembly 34. The function of the planetary gear assembly 34 is to reduce the rate of rotation so that the drum 12 is rotated by the planetary gear assembly 34 at a rate that is a fraction of the rotation of the drive shaft 28. Such gear reduction multiplies the torque produced by the motor 26 as transmitted to the drum 12. The brake mechanism 30 is mounted to the drive shaft 28 and brake shaft 32. The brake mechanism 30 functions to lock the brake shaft 32 to the drum 12. The planetary gear assembly 34 is thus unable to generate the rotational difference between the brake shaft 32 and the drum 12. The drum 12, the brake shaft 32 and the winch housing 14A, 14B are thus interlocked and rotation of the brake shaft 32 and the drum 12 are thereby stopped or braked.

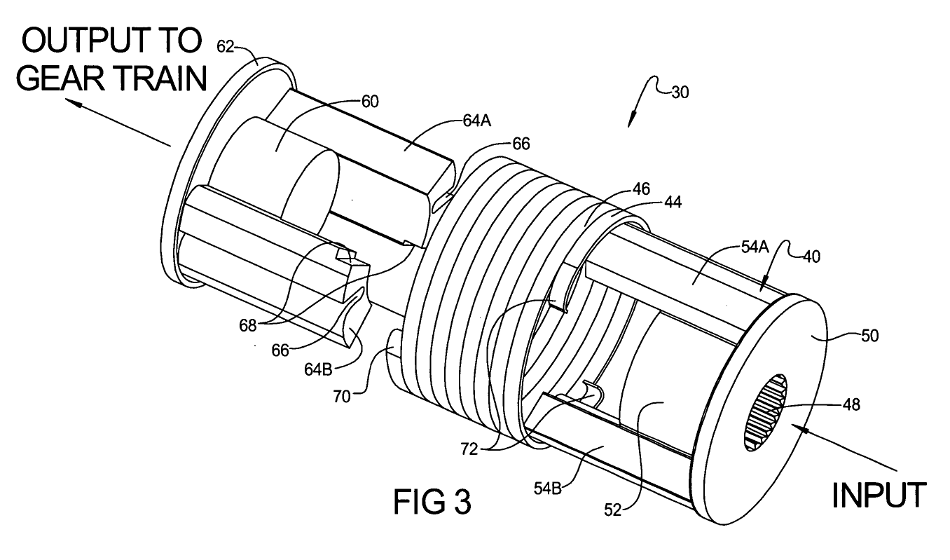

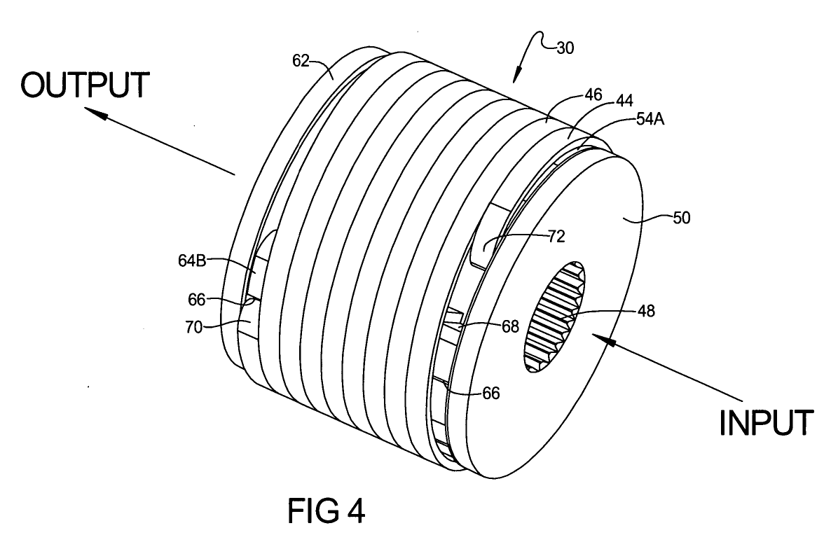

In reference to FIGS. 3 and 4, the brake mechanism 30 will now be described in greater detail. The brake mechanism 30 includes an input coupler 40, an output coupler 42 and a pair of torque coils 44, 46. The input coupler 40 is adapted to couple to the drive shaft 28 of the motor 26. In particular, the input coupler 40 includes an internally hexed or otherwise splined opening 48 provided in an end flange 50 which extends radially outward from a body portion 52. The body portion 52 is generally cylindrical in shape and includes a pair of axially extending arms 54A, 54B extending on opposite sides thereof and spaced approximately 180° from one another.

The output coupler 42 also includes a body portion 60 with a radially extending flange portion 62 extending therefrom. The end of the output coupler 42 is provided with a similar bore having an internally hexed or otherwise splined surface (not shown) that is similar to the bore 48 provided in the input coupler 40. A pair of axially extending arms 62A, 64B are provided on opposite sides of the cylinder body 60 and are spaced 180° from one another. Each of the axially extending arm portions 64A, 64B includes an axially extending slot or spring perch 66 provided in the outer surface thereof. The axially extending arm portions 64a, 64b also include a recess 68 provided at an end thereof.

The pair of torque coils 44, 46 are each inversely wound and intertwined with the end of each torque coil 44, 46 being bent inwardly to define a tang 70, 72 at each end thereof. The tangs 70, provided at a first end of the torque coil, are received in the spring perch 66 of the output coupler 42. The tangs 70 of the intertwined torque coils 44, 46 are opposed by 1800 from one another to provide symmetrical distribution of the braking torque against the inside surface of the winch drum 12. The second ends of the torque coils 44, 46 define free floating spring tangs 72 which are bent inward and which are free floating relative to the input and output couplers 40, 42. The torque coils 44, 46 surround the axially extending legs 54A, 54B and 64A, 64B of the input and output couplers 40, 42 which straddle one another such that the body portions 52, 60 of the input coupler 40 and output coupler 42 oppose one another.

When the motor 26 is at rest and a torque is applied to the winch drum 12 in the direction that would unwind the cable 20, the brake mechanism 30 is automatically actuated. The spring perches 66 of the output coupler 42 engage the spring tangs 70 from the output end of the intertwined torque coils 44, 46 and apply a moment on the torque coils 44,46 causing them to pivot about the spring perches 66 in a direction that causes the torque coils 44, 46 to be displaced outward radially, thereby transmitting braking torque between the output coupler 42 and the inside surface of the winch drum 12. Additionally, the brake mechanism 30 is self-energizing due to friction between the outside diameter of the torque coils 44, 46 and the inside surface of the winch drum 12, encouraging the torque coils 44, 46 to expand against the winch drum 12 further increasing the braking force. The input end of the intertwined torque coils 44, 46 are unrestrained and allow compliance with the braking demands of the system. The free floating ends 72 of the torque coils 44, 46 help dampen the rotational speed difference between the output coupler 42 and the winch drum 12. Brake mechanism 30 is released when the motor 26 is powered in either direction. When the motor 26 is powered in a direction that would wind the cable 20 out, the input coupler 40 engages the free-floating end 72 of the intertwined torque coil 44, 46 in a manner that relaxes the braking force being exerted on the inside surface of the drum 12 by the torque coils 44, 46.

If the motor 26 is powered in a direction that would wind the cable inward, the input coupler 40 directly engages the output coupler 42 which drives the intertwined torque coils in a direction that relaxes the braking force against the inside surface of the drum 12 by causing the torque coils 44, 46 to be displaced radially inward. The direct engagement of the input coupler 40 to the output coupler 42 provides a solid coupling between the motor 26 and winch gear train 34, eliminating the transmission of winch driving torque to the intertwined torque coils 44, 46. If the rotational speed of the output coupler 42 exceeds the rotational speed of the input coupler 40, the solid coupling between these components ceases to exist and the brake will automatically actuate since the torque coils 44, 46 would be caused to expand radially outward such as when the motor is at rest. With the brake mechanism 30 of the present invention, the number of components is significantly reduced and the assembly of the brake mechanism is simplified.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A winch comprising:
a housing;
a cable drum assembly having opposed ends and an exterior surface, said drum assembly rotatably mounted to the housing and a cable mounted to the exterior surface of the drum to be wound onto and off of the drum upon alternate rotation of the drum;
a motor mounted to the housing and including a drive shaft, a brake shaft coupled to the motor drive shaft, a gear reducer mechanism engaged with the brake shaft, said gear reducer mechanism engaged with the drum and configured to reduce the rotational affect of the drive shaft as applied to the drum; and
a braking mechanism coupling said drive shaft and said brake shaft and rotatable therewith and movable between engaged and disengaged frictional braking engagement with a brake surface whereby, when engaged, a relative rotative movement between the brake shaft and drum is resisted, said braking mechanism including at least one torque coil which expands radially outwardly to frictionally engage said brake surface when the motor is at rest and a torque is applied to the cable drum in a direction that would unwind the cable.

2. The winch according to claim 1, wherein said braking mechanism further includes an input coupler attached to said drive shaft and an output coupler attached to said brake shaft, said at least one torque coil including a first end engaged with said output coupler and a second end movable into engagement with said input coupler.

3. The winch according to claim 2, wherein said input coupler and said output coupler each include at least one axially extending arm wherein said axially extending arm of said input coupler is engageable with said axially extending arm of said output coupler.

4. The winch according to claim 1, wherein said at least one torque coil includes a pair of torque coils that are intertwined.

5. The winch according to claim 4, wherein ends of said pair of torque coils are rotatably opposed by 180 degrees and each of said pair of torque coils have an end engaging said output coupler.

6. The winch according to claim 5, wherein said output coupler includes a pair of axially extending legs that are engaged by said end of one of said pair of torque coils.

7. A winch comprising:
a housing;
a cable drum assembly having opposed ends and a cylindrical exterior surface, said drum assembly rotatably mounted to the housing and a cable mounted to the exterior surface of the drum to be wound onto and off of the drum upon alternate rotation of the drum;
a motor having a drive shaft mounted to the housing at one end of the drum, a brake shaft coupled to the motor drive shaft and extended toward the opposite end of the drum, a gear reducer mechanism at said opposite end engaged with the brake shaft, said gear reducer mechanism engaged with the drum and configured to reduce the rotational affect of the drive shaft as applied to the drum;
a brake surface on said cable drum assembly; and
a braking mechanism coupling said drive shaft and said brake shaft and rotatable therewith and movable between engaged and disengaged frictional braking engagement with said brake surface of the drum assembly whereby, when engaged, a relative rotative movement between the brake shaft and drum is resisted, said braking mechanism including at least one torque coil which expands radially outwardly to frictionally engage said brake surface on said cable drum assembly when the motor is at rest and a torque is applied to the cable drum in a direction that would unwind the cable.

8. The winch according to claim 7, wherein said braking mechanism further includes an input coupler attached to said drive shaft and an output coupler attached to said brake shaft, said at least one torque coil including a first end engaged with said output coupler and a second end movable into engagement with said input coupler.

9. The winch according to claim 8, wherein said input coupler and said output coupler each include at least one axially extending arm wherein said axially extending arm of said input coupler is engageable with said axially extending arm of said output coupler.

10. The winch according to claim 7, wherein said at least one torque coil includes a pair of torque coils that are intertwined.

11. The winch according to claim 10, wherein ends of said pair of torque coils are rotatably opposed by 180 degrees and each of said pair of torque coils have an end engaging said output coupler.

12. The winch according to claim 11, wherein said output coupler includes a pair of axially extending legs that are engaged by said end of one of said pair of torque coils.

13. A winch comprising:
a housing;
a cable drum assembly having opposed ends and an exterior surface, said drum assembly rotatably mounted to the housing and a cable mounted to the exterior surface of the drum to be wound onto and off of the drum upon alternate rotation of the drum;
a motor mounted to the housing and including a drive shaft, a brake shaft coupled to the motor drive shaft, a gear reducer mechanism engaged with the brake shaft, said gear reducer mechanism engaged with the drum and configured to reduce the rotational affect of the drive shaft as applied to the drum; and
a braking mechanism coupling said drive shaft and said brake shaft and rotatable therewith and movable between engaged and disengaged frictional braking engagement with a brake surface whereby, when engaged, a relative rotative movement between the brake shaft and drum is resisted, said braking mechanism including a pair of torque coils which expand radially outwardly to frictionally engage said brake surface when the motor is at rest and a torque is applied to the cable drum in a direction that would unwind the cable.

14. The winch according to claim 13, wherein said braking mechanism further includes an input coupler attached to said drive shaft and an output coupler attached to said brake shaft, said pair of torque coils each including a first end engaged with said output coupler and a second end movable into engagement with said input coupler.

15. The winch according to claim 14, wherein said input coupler and said output coupler each include a pair of axially extending arms wherein said axially extending arms of said input coupler are engageable with said axially extending arms of said output coupler.

16. The winch according to claim 15, wherein ends of said pair of torque coils are rotatably opposed by 180 degrees and each of said pair of torque coils have an end engaging said output coupler.
